(19) United States
(12) Patent Application Publication
(10) Pub. No.: US 2026/0135646 A1
(43) Pub. Date: May 14, 2026

(54) METHOD, COMPUTER PROGRAM PRODUCT, AND TEST DEVICE FOR GENERATING A TEST DATA SET FOR TESTING A RECEIVER, AND TEST DATA SET

(71) Applicant: BitifEye Digital Test Solutions GmbH, Böblingen (DE)

(72) Inventors: Alexander Schmitt, Böblingen (DE); Valentina Unakafova, Böblingen (DE); Anton Unakafov, Böblingen (DE); Fabian Deuchler, Böblingen (DE)

(21) Appl. No.: 19/388,681

(22) Filed: Nov. 13, 2025

(30) Foreign Application Priority Data
Nov. 13, 2024 (DE) 10 2024 133 216.6

(51) Int. Cl. H04L 1/24

(52) U.S. Cl. CPC H04L 1/244; H04L 1/241

(57) ABSTRACT

A method for generating a test data set for testing or adapting a receiver includes transmitting the test data set to the receiver, capturing a receiver-side data set generated by the receiver based on the test data set, evaluating the receiver-side data set to determine a plurality of incorrectly received symbols and their respective positions in the receiver-side data set, forming a plurality of error-causing data sets by copying a respective section of the test data set having a predetermined length around the respective incorrectly received symbols, evaluating the error-causing data sets to determine a plurality of error-causing positions and/or error-causing patterns, generating at least one refined error-causing data set based on the error-causing positions and/or error-causing patterns, and modifying the test data set by embedding at least one re-fined error-causing data set in the test data set.

### CROSS REFERENCE TO RELATED APPLICATIONS

This application claims priority to German patent application DE 10 2024 133 216.6, filed Nov. 13, 2023, the entire content of which is incorporated herein by reference.

### TECHNICAL FIELD

The disclosure relates to a method, a computer program product, and a test device for generating a test data set for testing a receiver, as well as the test data set.

### BACKGROUND

Since 2010, in modern high-speed interfaces (HSI), the data rate has doubled every 3 to 4 years. In the meantime, data rates of more than 40 Gbit/s have been achieved by multiple high-speed interfaces, such as PCIe 6 and 7, IEEE 802.3ck and dj, and MIPI M-PHY G6.

However, conventional methods for receiver adaptation and verification are not suitable for fully-digital receivers, in particular at data rates larger than 100 Gbit/s. Conventional adaptation and verification methods evaluate the output signal according to receiver equalization, in order to determine metrics such as eye or bathtub diagrams or the signal-to-noise ratio (SNR). These methods are not suitable for new equalization methods, such as Maximum Likelihood Symbol Detection (MLSD), since discrete symbols are provided on the output side and not signals as with Continuous Time Linear Equalization (CTLE) or Decision Feedback Equalization (DFE).

Testing high-speed interfaces such as PCIe 7, IEEE 802.3dj is extremely difficult. On the one hand, the bandwidth of the test devices, such as oscilloscopes, signal analyzers, vector network analyzers, etc., increases more slowly than the transmission rates. Thus, for example, there are only a few mass-produced oscilloscopes which offer sufficient bandwidth for the calibration of a PCIe-7 test signal at 100 GHz or more. On the other hand, at high transmission rates, it becomes more and more difficult to compensate for the effects of the test devices and units on the signal. These problems can make it necessary to replace classic conformity tests with on-chip tests/self-test functions, as is already the case in the UCIe interfaces due to the very short transmission channel.

The error rates of modern receivers cannot be reliably measured using test sequences of practical length less than 1010 symbols. There are two main reasons for this:
1. The probability that an error will occur in a specific symbol of a data stream depends on many symbols before and after it. One of the causes of this are reflections which come from impedance errors in the transmission channel. In order to ensure that the method reliably captures reflections, test data should contain all symbol sequences which show effects of reflections. Since the positions of the reflections are not known in advance, the test data should contain all possible partial sequences of a specific length.
2. The presently used multistep signal codes mean that each symbol does not only have two possible values, as in the non-return-to-zero coding (NRZ), which was previously used, but rather four, as in the case of PAM4, and eight, as in the case of PAM8, etc. This means that a test data set which contains all symbol partial sequences of a specific length has to be much longer than in the case of a non-return-to-zero code.

In the case of PCIe 5-7, for example, one of the sources of the reflections is the plug connector between the add-in card and the system board. The typical time-of-flight between the plug connector and the die on the add-in card is approximately t=0.7 ns, so that reflections from a plug connector take place with a delay of 2t=1.4 ns. For PCIe 5, 6, and 7, this time is 45 UI (unit intervals), 45 UI, and 90 UI, respectively, which defines the minimum length of the symbol sequences that are to be used for testing. For the non-return-to-zero code, the test data set which combines all binary sequences of 45 UI is 245≈32·10¹² symbols long. Testing PCIe 5 RX using such a test data set would only take 1000 seconds, less than half an hour. For PAM4, the test data set is 4⁴⁵≈10²⁷ symbols long. Testing PCIe 6 RX using this data set would take millions of years. The situation is even worse for PCIe 7, since the test data set is 4⁹⁰ symbols long.

The measurement of the symbol error rate (SER) represents a challenge in such high-speed interfaces. The behavior of the receiver is characterized by the long term or “true symbol error rate”, which is defined as the ratio of the symbols incorrectly received by the receiver to the total number of the transmitted symbols over all possible data sequences. The symbol error rate measured for a test data set is to be larger than or equal to the true symbol error rate. The practical test data sets which are used therefore only contain a tiny percentage of the possible symbol sequences and do not permit a correct assessment of the true symbol error rate. The most loaded symbol sequences are (highly probably) underrepresented in the test data set, so that the probability is high that the measured symbol error rate rather underestimates the true symbol error rate.

### SUMMARY

It is therefore an object of the disclosure to provide ways in which improvements can be achieved here.

The object of the disclosure is achieved by a method for generating a test data set for testing, in particular for adapting, a receiver, the method including subjecting the receiver to the test data set, capturing a receiver-side data set based on the test data set, evaluating the receiver-side data set to determine a plurality of incorrectly received symbols and their respective positions in the receiver-side data set, forming a plurality of error-causing data sets by copying a respective section having predetermined length of the test data set around the respective incorrectly received symbols, evaluating the error-causing data sets to determine a plurality of error-causing positions and/or error-causing patterns and generating at least one refined error-causing data set based on the error-causing positions and/or error-causing patterns, and modifying the test data set by embedding at least one refined error-causing data set in the test data set.

The receiver can be a receiver component configured as a separate component, part of a chiplet, or also a component configured for the self-test (built-in test).

The test data set can be an initial test data set which is modified and optimized in the context of multiple test passes. In other words, the testing can begin with the initial test data set and is then continued with following generations of the modified and optimized test data set.

The test data set can include, for example, 5000 to 100,000 symbols. The symbols can be binary (logical one and logical zero), or also multivalued, for example, four-valued, for example, as in PAM4.

The test data set and the receiver-side data set provided by the receiver are compared to one another to determine incorrectly received symbols and their respective position in the test data set.

Sections having predetermined length of the test data set are then copied around the respective position of the incorrectly received symbol. These copied sections form a plurality of error-causing data sets.

The error-causing data sets are then changed to generate at least one or more refined error-causing data sets. For this purpose, one or more symbols are changed at a position different from the determined error-causing position. In other words, the incorrectly transmitted symbol remains untouched at its position, while other sections of the error-causing data sets are changed. These can be individual symbols or also error-causing patterns which are found.

Finally, the one or more refined error-causing data sets are then embedded in the initial test data set or a test data set of the current following generation in order to thus modify the test data set. In the context of a further test pass, it can then be established whether the modifications on the test data set result in an increased error frequency. An increased error frequency is assessed as an indication of an improved, because more critical, test data set, and these modifications are adopted for a further test pass. In contrast, if an increased error frequency is not established, the modifications are not adopted, i.e., a renewed test pass is carried out using the preceding generation of the test data set in another modified form.

With the method, a distortion in a transmission link (for example, positions of unequal reflections) can be identified, even if the equalized output signal is not available, for example, if Maximum Likelihood Sequence Detection (MLSD) is used.

Due to the identification of error-causing patterns, the method enables a more accurate calculation of a symbol error rate than by counting errors for a predefined test sequence. This is particularly important for multivalued signals, such as PAM4 and higher, in which the test data sets are probably not representative.

The method can be used with any signal modulation and is not restricted, for example, to a non-return-to-zero code or PAM4.

The method enables an automatic identification of weak points of the receiver on the basis of identified error-causing positions and error-causing patterns.

The iterative transmission of a test data set having small modifications enables complex statistics to be prepared automatically, which show how the symbols before and after the error influence an error probability.

According to one exemplary embodiment, the step of generating at least one refined error-causing data set by changing the respective error-causing data sets at a position other than the position of the incorrectly received symbol includes the following steps:
generating at least one evaluation data set by copying the respective symbols of the plurality of error-causing data sets at the respective identical position of the plurality of error-causing data sets, and
evaluating the evaluation data set to determine a symbol for the new refined error-causing data set at the position.

In other words, each error-causing data set of the plurality of error-causing data sets forms, for example, a row of a matrix and the evaluation data set can then be understood as a vector which is filled with the respective symbols at the respective identical position of the error-causing data sets. The evaluation data set therefore combines multiple errors of the plurality of error-causing data sets.

The evaluation data set is then evaluated to determine a symbol for a refined error-causing data set at the position. For this purpose, for example, an arithmetic mean of the values of the symbols of the evaluation data set can be determined. If, for example, the determined value of the arithmetic mean is in the range of the upper limit of the possible value range, such as of a PAM4 signal, this is indicative that symbols having rather high values in the range of the upper limit are error-causing. In contrast, if the determined value of the arithmetic mean is in the range of the lower limit of the possible value range of the PAM4 signal, this is indicative that symbols having rather low values in the range of the lower limit are error-causing. Instead of the determination of the arithmetic mean, other methods are also conceivable. For example, instead of the arithmetic mean, a geometric or root square mean can also be determined. Furthermore, a median value can also be determined. The method can thus be significantly improved.

According to a further exemplary embodiment, the step of generating at least one re-fined error-causing data set by changing the respective error-causing data sets at a position other than the position of the incorrectly received symbol includes the following step:
sorting the error-causing data sets according to error frequency.

A list of the error-causing data sets is thus prepared, in which error-causing data sets having the highest error frequency are at the top and the error-causing data sets having the lowest error frequency are at the bottom. The error-causing data sets having the highest error frequency can thus be selected particularly easily.

According to a further exemplary embodiment, the step of generating at least one re-fined error-causing data set by changing the respective error-causing data sets at a position other than the position of the incorrectly received symbol includes the following step:
grouping the error-causing data sets.

Groups of error-causing data sets are thus formed. The group formation can be oriented to the error frequency, i.e., a group having the highest error frequency is formed, then a second group which has a lower error frequency than the first group, then a third group which has a lower error frequency than the second group, etc. The group formation can also be oriented to other features of the error-causing data sets, such as the type of the incorrectly transmitted symbol, its position, or to symbol sequences, such as error-causing patterns in the error-causing data sets. The method can thus be further improved.

According to a further exemplary embodiment, the step of generating at least one re-fined error-causing data set by changing the respective error-causing data sets at a position other than the position of the incorrectly received symbol includes the following step:
changing the position of the error-causing pattern in the error-causing data sets to determine a refined error-causing data set.

The error-causing pattern is thus removed at its original point in the error-causing data sets and inserted at another point into the error-causing data sets to determine the refined error-causing data set. The method can thus be still further improved.

According to a further exemplary embodiment, the step of generating at least one re-fined error-causing data set by changing the respective error-causing data sets at a point other than the error-causing positions includes the following step:
balancing out the test data set.

Balancing out the test data set is understood here to mean that the performed modifications of the refined error-causing data set at other positions are balanced out or compensated. The balancing out or compensating can be oriented to attempting a uniform distribution of the plurality of symbols. In the case of a PAM4 signal, each of the four possible symbols would then appear with the same frequency in the test data set. Alternatively, the balancing out or compensating can be oriented to keeping constant an energy content of the test data set, i.e., chronologically over the test data set.

Furthermore, the disclosure includes a computer program product configured to carry out such a method, a test data set determined according to such a method, and a test device.

### BRIEF DESCRIPTION OF THE DRAWINGS

The disclosure will now be described with reference to the drawings wherein:

FIG. 1 shows a schematic representation of a test arrangement for testing a receiver,

FIG. 2 shows a schematic representation of details of the method for testing the receiver,

FIG. 3 shows a schematic representation of further details of the method for testing the receiver, and

FIG. 4 shows a schematic representation of a method sequence for testing the receiver.

### DESCRIPTION OF EXEMPLARY EMBODIMENTS

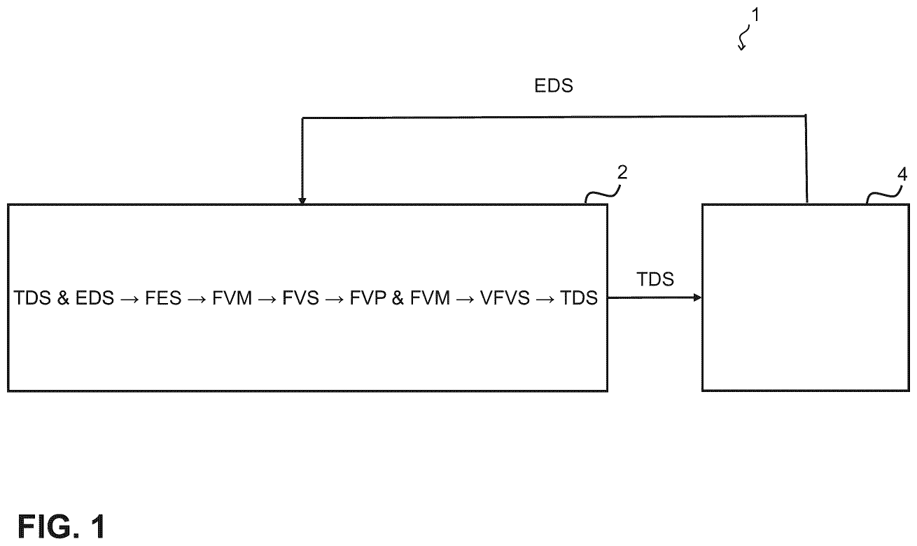

Reference is first made to FIG. 1. In FIG. 1, a test arrangement 1 having a test device 2 for testing a receiver 4 having a high-speed interface is shown.

The test device 2 can be configured in the present exemplary embodiment as a separate component, for example, as a transmitter component, in particular a test unit component, or can be part of a chiplet or also a component configured for the self-test (built-in test).

The receiver 4 can be configured in the present exemplary embodiment as a separate component, for example, as a receiver component, or can be part of a chiplet or also a component configured for the self-test (built-in test).

A chiplet includes a plurality of chips (DIE), which are also different, together in a housing (Multi Die Package). Chiplets can be combined both monolithically and non-monolithically to form a complete system functionality.

Users are computing centers, high-performance computing (HPC), and artificial intelligence (AI). The markets for entertainment electronics, telecommunication, and automobiles are also increasingly using chiplets.

In operation, the test device 2 subjects the receiver 4 to an initial test data set TDS, and the test device 2 inputs the receiver-side data set EDS provided by the receiver 4, which is based on the test data set TDS.

Based on an evaluation of the initial test data set TDS and the receiver-side data set EDS, the test device 2 modifies the test data set TDS in order to again subject the receiver 4 thereto. The method is then continued with further passes, wherein the test data set TDS is modified in each pass. In other words, an iterative process is carried out to improve the test data set TDS again and again in steps.

For this purpose and for the tasks and/or functions described hereinafter, the test device 2 can include correspondingly configured hardware and/or software components. The hardware components can be components of a computer, such as a processor and a non-transitory computer-readable storage medium, on which the computer program product for carrying out the method is stored, which is executed by the processor.

Therefore, the test device 2 in the present exemplary embodiment is configured to generate an initial test data set TDS and then further test data sets TDS and to subject the receiver 4 thereto.

The test data set TDS can include, for example, 5,000 to 100,000 symbols. In the present exemplary embodiment, a four-value signal is used, such as a PAM4 signal. Notwithstanding the present exemplary embodiment, a binary or higher-value signal, such as a PAM8 signal, can also be used.

Furthermore, the test device 2 in the present exemplary embodiment is configured to capture the receiver-side data set EDS based on the initial or following test data set TDS and to evaluate the receiver-side data set EDS in order to determine a plurality of error-causing positions FVP and/or error-causing patterns FVM in the receiver-site data set EDS.

For this purpose, the test device 2 in the present exemplary embodiment is configured to compare the initial and the following test data sets TDS with the respective corresponding receiver-side data sets EDS in order to determine incorrectly received symbols FES and their respective positions in the test data set TDS.

Furthermore, the test device 2 in the present exemplary embodiment is configured to find error-causing patterns FVM, which are within a section having predetermined length of the test data set TDS around the incorrectly transmitted symbol.

The test device 2 in the present exemplary embodiment is furthermore configured to copy the respective sections having predetermined length of the test data set TDS around the respective incorrectly received symbols FES in order to form a plurality of error-causing data sets FVS.

In addition, the test device 2 in the present exemplary embodiment is configured to evaluate the error-causing data sets FVS in order to determine a plurality of error-causing positions FVP and/or error-causing patterns FVM.

In addition, the test device 2 in the present exemplary embodiment is configured to change the respective error-causing data sets FVS—based on an error-causing position FVP or an error-causing pattern FVM—in order to generate a plurality of refined error-causing data sets VFVS, as will be described in more detail below.

Finally, the test device 2 in the present exemplary embodiment is configured to embed the refined error-causing data sets VFVS thus formed in the respective test data set TDS in order to modify it.

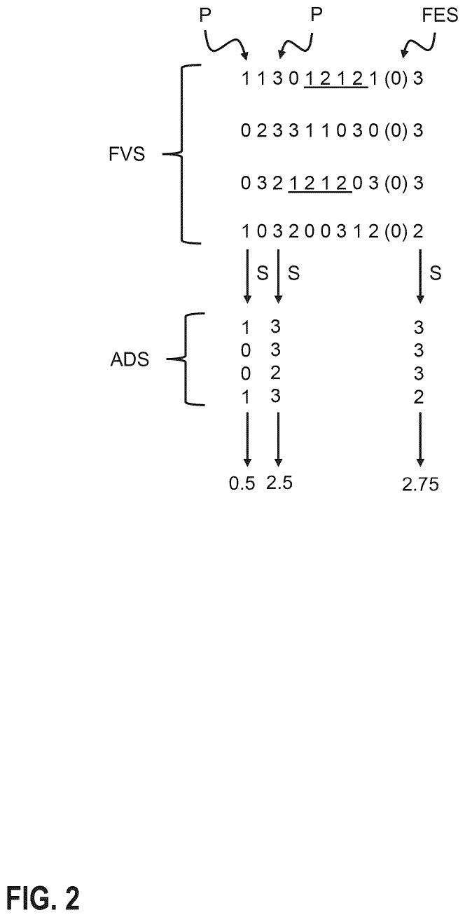

Reference is now additionally made to FIG. 2.

Four error-causing data sets FVS are shown, which were determined, for example, by comparing an initial test data set TDS to a corresponding receiver-side data set EDS.

In the present exemplary embodiment, the error-causing data sets FVS each have a length of 11 symbols S. In each case the symbol FES between parentheses having the value zero at the tenth point was incorrectly received. In other words, the error-causing data sets FVS include, in addition to the incorrectly received symbol FES at the tenth point, nine preceding symbols S and one following symbol S.

Furthermore, the error-causing pattern FVM was determined in the present exemplary embodiment by comparison in the first and in the third error-causing data set FVS. It extends in the first error-causing data set FVS from the fifth to the eighth position, while it extends in the third error-causing data set FVS from the fourth to the seventh position.

It is to be noted that the four error-causing data sets FVS were each detected multiple times as incorrect and grouped accordingly. In other words, the four error-causing data sets FVS are contained multiple times in the test data set TDS. Furthermore, the four error-causing data sets FVS were sorted according to their error frequency.

In the present exemplary embodiment, 40% of the errors occurred in the first of the four error-causing data sets FVS, 20% of the errors occurred in each of the second and third of the four error-causing data sets FVS, and 10% of the errors occurred in the fourth of the four error-causing data sets FVS. A further 10% of the errors occurred in other data sets (not shown). Therefore, in the present exemplary embodiment, 90% of the errors occur here in four error-causing data sets FVS.

Furthermore, in the present exemplary embodiment, 60% of the errors occurred after the error-causing pattern FVM.

A condition for the further evaluation is that a predetermined minimum number of errors was detected.

To evaluate the four error-causing data sets FVS, evaluation data sets ADS are formed by the test device 2, specifically one evaluation data set ADS for each symbol position. For this purpose, the respective symbols S of the error-causing data sets FV are copied at the respective identical position P of the error-causing data sets FVS and compiled to form the respective evaluation data sets ADS.

In the present exemplary embodiment, the four error-causing data sets FVS can be understood as a matrix, while the respective evaluation data sets ADS can be understood as vectors.

The evaluation data sets ADS thus formed are then evaluated. For this purpose, in the present exemplary embodiment, the average value or arithmetic mean value of the values of the symbols S of the respective evaluation data sets ADS is determined by the test device 2. In the case of the evaluation data set ADS, a value of 0.5 results for the first position P, and a value of 2.5 results for the third position P. A value of 2.5 also results for the last position P.

If it is presumed that errors occur particularly frequently at extreme values, i.e., the maximum value, in the case of PAM4 a value of 3, and the minimum value, zero, the first value of 0.5 is indicative of the minimum value of zero, while the value 2.5 is indicative of the maximum value of 3.

As a result, the four error-causing data sets FVS have an identical structure in the format 0x3xxxxxx(0)3, i.e., the four error-causing data sets FVS have the symbol S for the minimum value zero at the first position P and the symbol S for the maximum value 3 at the third and last position P.

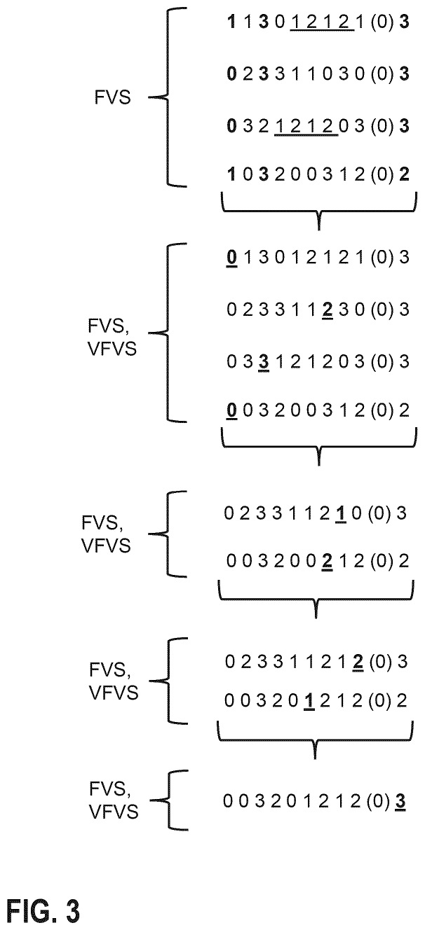

Reference is now additionally made to FIG. 3.

In FIG. 3, it is shown how, starting from the four error-causing data sets FVS of the first generation, four and later two error-causing data sets FVS of following generations are formed in each case.

The four error-causing data sets FVS of the second generation were changed by the test device 2 as follows in order to obtain the refined error-causing data sets VFVS: According to the above-determined values, in the first position P of the first and fourth error-causing data sets FVS of the first generation, the symbol S for the value 1 was replaced by the symbol S for the value zero. Furthermore, according to the above-determined values in the third error-causing data set FVS of the first generation, the symbol S for the value 2 at the third position P was replaced by the symbol S for the value 3. Furthermore, in the second error-causing data set FVS of the first generation, the symbol S for the value zero at the seventh position P was replaced by the symbol S for the value two, in order to reproduce the error-causing pattern FVM, which was previously identified in other error-causing data sets FVS.

In addition, balancing out by the test device 2 can be provided. For this purpose, for example, the symbol S for the value 3 at an arbitrary position P of the third of the four error-causing data sets FVS or also outside the third of the four error-causing data sets FVS, but within the test data set TDS, can be replaced by the symbol S for the value 1. Furthermore, for example, the symbol S for the value zero at an arbitrary position P of the first and/or fourth of the four error-causing data sets FVS or also outside the four error-causing data sets FVS, but within the test data set TDS, can be replaced by the symbol S for the value 1.

The four error-causing data sets FVS of the second generation or refined error-causing data sets VFVS are now used in a further pass to again subject the receiver 4 to them. For this purpose, the refined error-causing data sets VFVS are embedded in the test data set TDS.

An evaluation of the error frequency by the test device 2 has the result that the error frequency could not be increased in the first and third of the four error-causing data sets FVS, but in contrast could in the second and fourth of the four error-causing data sets FVS.

In the second of the four error-causing data sets FVS, the symbol S for the value 3 is replaced by the symbol S for the value 1 at the eighth position by the test device 2 and in the fourth of the four error-causing data sets FVS, the symbol S for the value 3 is replaced by the symbol S for the value 2 at the seventh position P in order to reproduce the error-causing pattern FVM.

The remaining two error-causing data sets FVS of the third generation are now used by the test device 2 in a further pass, as described above, in order to again subject the receiver 4 to them using a test data set TDS which is changed again. An evaluation of the error frequency by the test device 2 has the result that the error frequency again could not be increased with the first and third of the four error-causing data sets FVS, but could with the second and fourth of the four error-causing data sets FVS.

In the second of the four error-causing data sets FVS, the symbol S for the value zero is replaced by the symbol S for the value 2 at the ninth position P by the test device 2 and in the fourth of the four error-causing data sets FVS, the symbol S for the value zero is replaced by the symbol S for the value 1 at the sixth position P in order to reproduce the error-causing pattern FVM.

The remaining two error-causing data sets FVS of the third generation are now used in a further pass by the test device 2, as described above, in order to again subject the receiver 4 to them. An evaluation of the error frequency by the test device 2 has the result that the error frequency could not be increased with the second of the fourth error-causing data sets FVS, but could with the fourth of the four error-causing data sets FVS.

In the fourth of the four error-causing data sets FVS, the symbol S for the value 2 is replaced by the symbol S for the value 3 at the last position by the test device 2, because the evaluation data set ADS for the last position P results in a value of 2.5, which, as described above, results in the selection of the symbol S for the value 3.

If the error frequency cannot be increased by this change, it can be concluded therefrom that the last position P has no influence on the error frequency and is not an error-causing data set FVS. For further passes, the last changes can be reversed by the test device 2 and others can be performed in their place.

As a departure from the present exemplary embodiment, in the evaluation of the evaluation data sets ADS, the respective values of the symbols S can be weighted with their respective error rates, thus, for example, with the above-mentioned values 40%, 20%, and 10%.

Furthermore, as a departure from the present exemplary embodiment, it can be provided that in the evaluation of the evaluation data sets ADS, it is first checked by the test device 2 in a partial step whether the difference between the transmitted value of the symbol S of the test data set TDS and the corresponding value of the symbol S of the receiver-side data set EDS at the respective error position of the test data set TDS and the receiver-side data set EDS is larger or less than zero.

If the difference is larger than zero, the corresponding value of the symbol S at the error-causing position FVP, which is different than the error position, of the evaluation data sets ADS remains unchanged. In contrast, if the difference is less than zero, in a further partial step, the symbol S of the evaluation data sets ADS is inverted by the test device 2.

In the present exemplary embodiment, for the inversion the value W of the symbol S at the error-causing position FVP is subtracted from the maximum value of the signal Smax: Smax−W. In the case of a PAM4 signal, the maximum value is 3, thus 3−W.

For example, the following occur in the three error-causing data sets FVS
50% errors in 1130(0)3,
25% errors in 3100(3)0, and
25% errors in 0321(0)3
   with the incorrectly received symbols S zero and 3 at the next-to-last position of these character sequences.

The respective error rates for these three error-causing data sets FVS are then 0.5 and 0.25 two times.

Furthermore, for the first and the third of the three error-causing data sets FVS, the inversion is carried out since zero was received as the incorrectly received symbol S. Therefore, the correct symbol S has to stand for a value W larger than zero and the difference has to be less than zero. Vice versa, in the second of the three error-causing data sets FVS, the difference has to be larger than zero, since 3 was received as the symbol.

An average profile value based on a first evaluation data set ADS based on the first positions is then calculated as

$$= 0.5 \cdot ( 3 - 1 ) + 0.25 \cdot 3 + 0.25 \cdot ( 3 - 0 ) = 1 + 0.75 + 0.75 = 2.5 .$$

Analogously, further average profile values based on the further evaluation data sets ADS based on the further positions result as 1.25; 0.25; 2; 3; and zero.

In general, the average profile values can be calculated as follows:

$$Average profile value ( n ) = {\sum }_{k = 1}^{K} {FR}_{k} \cdot {signedFVS}_{k} ( n )$$

$$wherein$$

$${signedFVS}_{k} ( n ) = \{ \begin{matrix}{FVS}_{k} ( n ) , & for {FZ}_{k} = 1 \\ Smax - {FVS}_{k} ( n ) , & for {FZ}_{k} = - 1\end{matrix}$$

Smax is the maximum symbol value for the applied code (Smax=3 for PAM4), FRₖ is the error rate of the kth FVS error-causing data set FVS, FZₖ is the error character for the kth error-causing data set FVS, FZₖ=1 if transmitted symbol−received symbol>0, (for example, “3” was transmitted and “2” was received: (3-2)>0), FZₖ=−1 if transmitted symbol−received symbol<0 (for example, “0” was transmitted and “1” was received: (0-1)<0), and FVSₖ(n) is the n^{th} symbol of the k^{th} error-causing data set FVS.

For the adaptation of the symbols S in the error-causing data sets FVS to obtain the refined error-causing data sets VFVS, it can furthermore be provided that a threshold value comparison is carried out using a lower and an upper threshold value and the respective values are only changed if the lower threshold value or the upper threshold value is exceeded. For example, in the case of PAM4, the lower threshold value can be 0.5 and the upper threshold value can be 2.5.

Furthermore, the upper threshold value oSW and the lower threshold value uSW can be adapted progressively, i.e., during each pass. For this purpose, the number of the nonrandom errors ANF in relation to the total number of errors GF can be weighted using predetermined weighting values, for example, using the weighting value GW=0.5, and then subtracted from a lower uOffset of 1.25 and added to an upper oOffset of 1.75:

$$uSW = uOffset - GW \cdot ANF / GF$$

$$oSW = oOffset + GW \cdot ANF / GF .$$

Expressed more generally, this parameter characterizes the randomness of the errors and enables the method to adapt itself to the channel conditions. In a transmission channel dominated by noise, the ratio of the number of the nonrandom errors ANF in relation to the total number of the errors GF can be close to zero, while in a transmission channel dominated by inter-symbol interference (ISI), the ratio of the number of the nonrandom errors ANF in relation to the total number of the errors GF is close to 1.

For example, oSW=2.25 can apply for the upper threshold value and uSW=0.75 can apply for the lower threshold value.

The average profile from the above example includes the values
2.5 1.25 0.25 2 3 0

The positions P, which were selected for the update of this on the basis of the comparison with the upper threshold value oSW and the lower threshold value uSW are emboldened (the value “3” is not emboldened, since it is at the error-causing position FVP).

Symbols S for the refined error-causing data sets VFVS result from the average profile, which maximize the probability of an error with negative sign FZₖ=−1 and an error with positive sign FZₖ=1:

$$3 * 0 * 0 ( 3 ) 0$$

$$and$$

$$0 * 3 * ( 0 ) 3.$$

The symbols S in each error-causing data set FVS are updated as follows to correspond to the average profile values:
1130(0)3→−0130(0)3 (at the first position P, the symbol 1 is replaced by the symbol 0, since this this sequence has FZₖ=−1, i.e. the inverted 0 is 3),
3100(3)0→no changes, and
0321(0)3→0331(0)3 (at the third position P, the symbol 2 is replaced by the symbol 3, since this sequence has FZₖ=1, i.e., the inverted 3 is 0).

In this case, only one change is carried out in each error-causing data set FVS during each pass in the present exemplary embodiment, in order to thus obtain the refined error-causing data sets VFVS for embedding in the modified test data set TDS.

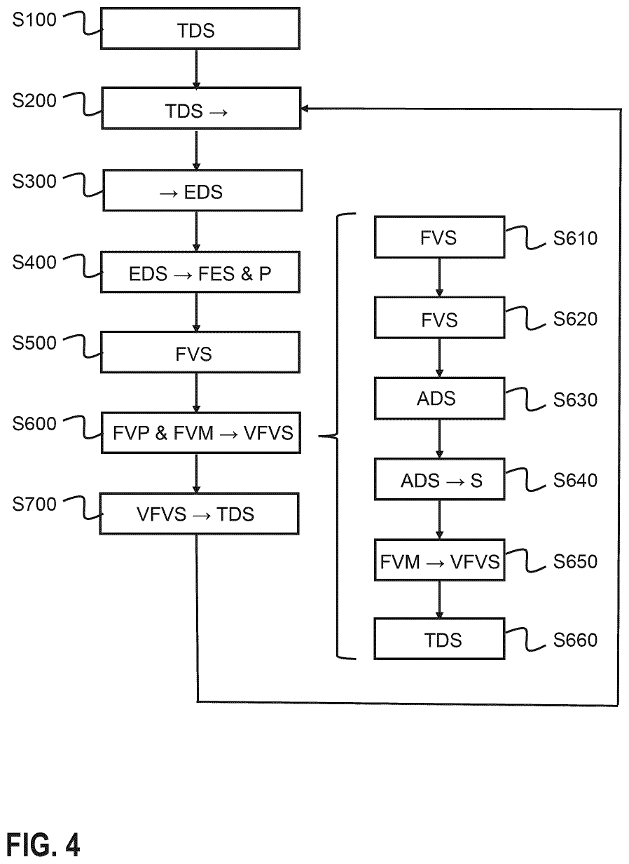

Reference is now additionally made to FIG. 4.

In a first step S100, the receiver 4 is provided with the initial test data set TDS having a predetermined length by the test device 2.

In a further step S200, the test device 2 subjects the receiver 4 to the initial test data set TDS or to following generations of the initial test data set TDS, i.e., further test data sets TDS.

In a further step S300, the test device 2 captures the receiver-side data set EDS based on the respective current test data set TDS.

In a further step S400, the test device 2 evaluates the receiver-side data set EDS in order to determine a plurality of error-causing positions FVP.

In a further step S500, the test device 2 forms a plurality of error-causing data sets FVS by copying a respective section having predetermined length of the test data set TDS around the respective incorrectly received symbols FES.

In a further step S600, the test device 2 evaluates the error-causing data sets FVS in order to determine a plurality of error-causing positions FVP and/or error-causing patterns FVM and generates at least one refined error-causing data set VFVS based on the error-causing positions FVP and/or error-causing patterns FVM.

In a further step S610, the test device 2 sorts the error-causing data sets FVS according to error frequency for this purpose.

In a further step S620, the test device 2 groups the error-causing data sets FVS for this purpose.

In a further step S630, the test device 2 generates at least one evaluation data set ADS by copying the respective symbols S of the plurality of error-causing data sets FVS at the respective identical position P of the plurality of error-causing data sets FVS.

In a further step S640, the test device 2 evaluates the evaluation data set ADS in order to determine a symbol S for a refined error-causing data set VSVF at the position P.

In a further step S650, the test device 2 changes the position of the error-causing pattern FVM in the error-causing data sets FVS to determine a refined error-causing data set VFVS.

In a further step S660, the test device 2 balances out the test data set.

In a further step S700, the test device 2 modifies the test data set TDS by embedding at least one of the plurality of the refined error-causing data sets VFVS in the test data set TDS.

On the basis of the identified error-causing positions FVP and error-causing patterns FVM, the capability of the receiver 4 to reproduce the data from the incoming signal can be characterized. This characterization also enables the adaptation, for example, of Clock Data Recovery settings (CDR). Various options are possible, for example:
1. Adapting the receiver 4 to minimize the effects of the error-causing positions FVP. This can be carried out, for example, by the application of FTDFE taps (Floating-Tap Decision Feedback Equalization) at the error-causing positions FVP, by the adaptation of the Maximum Likelihood Sequence Detection parameters (MLSD), or by the change of the equilibrium between transmitter and feedforward equalizations (FFEs).
2. Optimizing the clock data recovery (CDR) to minimize the effects of the error-causing patterns FVM. Error-causing patterns FVM in which specific symbol transitions are under- or overrepresented are probably an indicator of clock data recovery problems.
3. Optimizing Maximum Likelihood Sequence Detection (MLSD) to minimize the effects of error-causing patterns FVM. The presence of error-causing patterns FVM can indicate suboptimal Maximum Likelihood Sequence Detection settings.
4. Calculating the true symbol error rate and its use as a performance characteristic number. In particular, the symbol error rate can be calculated in that all combinations of error-causing positions FVP and/or error-causing patterns FVM are numbered from 1 to N, as Σ_{i=1 . . . N} FRᵢ·pᵢ, wherein FRᵢ is the error rate for the i^{th} combination of error-causing positions FVP and/or error-causing patterns FVM and pᵢ is the probability of this combination.

For the exemplary calculation of the symbol error rate, it is assumed that the error rates for the following combinations of error-causing positions FVP and/or error-causing patterns FVM were determined as follows (irrelevant symbols were replaced by an asterisk):

$$0 * 3 ** 1212 ( 0 ) = 0 \text{.007}$$

$$1 * 3 ** 1212 ( 0 ) = 0.0 \; 03$$

$$1 * 2 ** 1212 ( 0 ) = 0.0 \; 01$$

$$1 * 2 ** 1212 ( 0 ) = 0.0 \; 006$$

$$0 * 3 * 1212 * ( 0 ) = 0.0 \; 03$$

$$1 * 3 * 1212 * ( 0 ) = 0.0 \; 01$$

$$0 * 2 * 1212 * ( 0 ) = 0.0 \; 007$$

$$1 * 2 * 1212 * ( 0 ) = 0.0 \; 001$$

$$0 * 3 ** ** ** ( 0 ) = 0.0 \; 00004$$

$$1 * 3 ** ** ** ( 0 ) = 0.0 \; 0002$$

$$0 * 2 ** ** ** ( 0 ) = 0.00001$$

The error rates for the other combinations should be negligible. The first eight combinations have 8 defined PAM4 symbols, so that their relative frequency in the data stream is 1/(4⁷). The last three combinations have 3 fixed PAM4 symbols, so that their relative frequency is 1/(4³).

The true symbol error rate results as follows:

$$\begin{matrix}= 0.001 * ( 7 + 3 + 3 + 1 + 1 + 0.7 + 0.06 + 0 \text{.3} ) / {4}^{7} + 0.00001 * ( 4 + 2 + 1 ) / {4}^{3} \\ = ( 0. 01 \; 64 ) / 16384 + ( 0.000 \; 07 ) / 64 \\ = 2.1069 * {10}^{- 6} .\end{matrix}$$

This example is simplified: If the error probability is only dependent on 8 preceding symbols S, the symbol error rate itself can be reliably estimated from a short test data set (4⁹=262144 symbols). The above approach functions in the same manner if error-causing positions FVP and/or error-causing patterns FVM are distributed over several hundred symbols S, which is generally the case in realistic transmission channels if the measured symbol error rate from a finite test data set is probably an unreliable estimation for the true symbol error rate.

Using the method, a distortion in a transmission channel (for example, positions of unequal reflections) can be identified, even if the equalized output signal is not available, for example, if Maximum Likelihood Sequence Detection (MLSD) is used.

By way of the identification of error-causing patterns FVM, the method enables a more accurate calculation of symbol error rates than by counting errors for a predefined test sequence. This is particularly important for multi-value signals, such as PAM4 and higher, for which the test data sets are probably not representative.

The method can be used with any signal modulation and is not restricted, for example, to a non-return-to-zero code or PAM4.

The method enables an automatic identification of weak points of the receiver 4 on the basis of identified error-causing positions FVP and/or error-causing patterns FVM.

The iterative transmission of a test data set TDS with small modifications enables complex statistics to be prepared automatically, which show how symbols S before and after the error influence the probability of the error.

### LIST OF REFERENCE NUMERALS

1 test arrangement
2 test device
4 receiver
ADS evaluation data set
EDS receiver-side data set
FES incorrectly received symbol
FVM error-causing pattern
FVP error-causing position
FVS error-causing data set
P position
S symbol
TDS test data set
VFVS refined error-causing data set
S100 step
S200 step
S300 step
S400 step
S500 step
S600 step
S610 step
S620 step
S630 step
S640 step
S650 step
S700 step

What is claimed is:

1. A method for generating a test data set for testing or adapting a receiver, the method comprising:
transmitting the test data set to the receiver;
capturing a receiver-side data set generated by the receiver based on the test data set;
evaluating the receiver-side data set to determine a plurality of incorrectly received symbols and respective positions of each of the plurality of the incorrectly received symbols in the receiver-side data set;
forming a plurality of error-causing data sets by copying a respective section of the test data set having a predetermined length around respective incorrectly received symbols;
evaluating the plurality of error-causing data sets to determine at least one of (1) a plurality of error-causing positions, and (2) a plurality of error-causing patterns;
generating at least one refined error-causing data set based on at least one of (3) the plurality of error-causing positions, and (4) the plurality of error-causing patterns; and
modifying the test data set by embedding at least one refined error-causing data set in the test data set.

2. The method as claimed in claim 1, wherein generating the at least one refined error-causing data set by changing respective error-causing data sets at a position other than the position of the incorrectly received symbol comprises:
generating at least one evaluation data set by copying respective symbols of the plurality of error-causing data sets at a respective identical position of the plurality of error-causing data sets; and
evaluating the evaluation data set to determine a symbol for a new refined error-causing data set at the position.

3. The method as claimed in claim 1, wherein generating the at least one refined error-causing data set by changing the respective error-causing data sets at a position other than the position of the incorrectly received symbol comprises:
sorting the error-causing data sets according to error frequency.

4. The method as claimed in claim 1, wherein generating the at least one refined error-causing data set by changing the respective error-causing data sets at a position other than the position of the incorrectly received symbol comprises:
grouping the error-causing data sets.

5. The method as claimed in claim 1, wherein generating the at least one refined error-causing data set by changing the respective error-causing data sets at a position other than the position of the incorrectly received symbol comprises:
changing the position of the error-causing pattern in the error-causing data sets to determine a refined error-causing data set.

6. The method as claimed in claim 1, wherein generating the at least one refined error-causing data set by changing the respective error-causing data sets at a position other than the position of the incorrectly received symbol comprises:
balancing out the test data set.

7. A non-transitory computer-readable storage medium on which a computer program product is stored, which, when executed on a processor causes the processor to carry out the method as claimed in claim 1.

8. The test data set determined according to the method as claimed in claim 1.

9. A test device for generating a test data set for testing or adapting a receiver, the test device comprising:
a non-transitory computer-readable storage medium on which a computer program is stored; and
a processor in communication with the non-transitory computer-readable storage medium, the computer program, when executed by the processor, causing the processor to:
transmit the test data set to the receiver,
capture a receiver-side data set generated by the receiver based on the test data set,
evaluate the receiver-side data set to determine a plurality of incorrectly received symbols and respective positions of each of the plurality of the incorrectly received symbols in the receiver-side data set,
form a plurality of error-causing data sets by copying a respective section of the test data set having a predetermined length around the respective incorrectly received symbols,
evaluate the plurality of error-causing data sets to determine at least one of (1) a plurality of error-causing positions, and (2) a plurality of error-causing patterns,
generate at least one refined error-causing data set based on at least one of (3) the plurality of error-causing positions, and (4) the plurality of error-causing patterns, and
modify the test data set by embedding at least one refined error-causing data set in the test data set.

10. The test device as claimed in claim 9, wherein the computer program, when executed by the processor, further causes the processor to:
generate at least one evaluation data set by copying respective symbols of the plurality of error-causing data sets at a respective identical position of the plurality of error-causing data sets, and
evaluate the evaluation data set to determine a symbol for the refined error-causing data set at the position.

11. The test device as claimed in claim 9, wherein the computer program, when executed by the processor, further causes the processor to sort the error-causing data sets according to error frequency.

12. The test device as claimed in claim 9, wherein the computer program, when executed by the processor, further causes the processor to group the error-causing data sets.

13. The test device as claimed in claim 9, wherein the computer program, when executed by the processor, further causes the processor to change the position of the error-causing pattern in the error-causing data sets to determine a refined error-causing data set.

14. The test device as claimed in claim 9, wherein the computer program, when executed by the processor, further causes the processor to balance out the test data set.
